(19) United States
(12) Patent Application Publication
(10) Pub. No.: US 2021/0080662 A1
(43) Pub. Date: Mar. 18, 2021

(54) ALIGNMENT FEATURES FOR FIBER TO CHIP ALIGNMENT

(71) Applicant: Cisco Technology, Inc., San Jose, CA (US)

(72) Inventors: Ashley J.M. ERICKSON, Danville, CA (US); Anthony D. KOPINETZ, York, PA (US); Vipulkumar K. PATEL, Breinigsville, PA (US)

(21) Appl. No.: 16/570,040

(22) Filed: Sep. 13, 2019

(51) Int. Cl. G02B 6/42

(52) U.S. Cl. CPC G02B 6/4231; G02B 6/4243

(57) ABSTRACT

Embodiments herein describe an optical array unit configured to couple a photonic die with a plurality of optical fibers. The optical array unit includes alignment features which engage with alignment features on a corresponding photonic die. The engaged alignment features reduce the need for active alignment while also reducing the complexities of traditional passive alignment features.

### TECHNICAL FIELD

Embodiments presented in this disclosure generally relate to techniques for optical alignment of multiple optical fibers with waveguides of a substrate and/or photonic die.

### BACKGROUND

Many approaches have been proposed for improving optical coupling between optical fiber(s) and semiconductor chips. However, such approaches can require precisely-machined interlocking features, expensive piece parts, time intensive alignment processes, and complex fiber array unit (FAU) and chip designs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A illustrates an example optical transceiver, according to embodiments described herein.

FIG. 1B illustrates an example inside view of an optical transceiver, according to embodiments described herein.

FIG. 2A illustrates an example optical fiber array unit, according to embodiments described herein.

FIG. 2B illustrates an example photonic die, according to embodiments described herein.

FIG. 2C illustrates an example top view of an optical array unit engaged with a photonic die, according to embodiments described herein.

FIGS. 2D-E illustrates example side views of an optical array unit engaged with a photonic die, according to embodiments described herein.

FIG. 3A illustrates an example shallow diced optical array unit, according to embodiments described herein.

FIG. 3B illustrates an example side view of a shallowed diced optical array unit engaged with a photonic die, according to embodiments described herein.

FIG. 4A illustrates an example optical array unit with preformed recessed alignment features, according to embodiments described herein.

FIG. 4B illustrates an example top view of an optical array unit with preformed recessed alignment features engaged with a photonic die, according to embodiments described herein.

FIG. 5A illustrates an example optical array unit with hole features, according to embodiments described herein.

FIG. 5B illustrates an example photonic die with pin features, according to embodiments described herein.

FIG. 5C illustrates an example top view of an optical array unit with hole features engaged with a photonic die with pin features, according to embodiments described herein.

FIG. 5D illustrates an example side view of an optical array unit with hole features engaged with a photonic die with pin features, according to embodiments described herein.

FIG. 6 is a flowchart illustrating operations of an example method for the production of an optical array unit, according to embodiments described herein.

FIGS. 7A-N illustrate various views of the production of an optical array unit, according to embodiments described herein.

FIGS. 8A-E illustrate various views of the production of an optical array unit with preformed alignment features, according to embodiments described herein.

FIG. 9 is a block diagram of a system for constructing an optical apparatus, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DESCRIPTION OF EXAMPLE EMBODIMENTS

### Overview

One general aspect includes an apparatus, including: an optical array unit. The optical array unit includes: a plurality of optical paths optically connected to a connection edge of the optical array unit; one or more recessed alignment features formed in the optical array unit. The apparatus also includes a photonic die including: a plurality of waveguides formed in the photonic die and optically connected to a connection edge of the photonic die; and one or more protruding alignment features extending from an alignment surface of the photonic die, where each of the one or more protruding alignment features is dimensioned to engage with a respective recessed alignment features of the one or more recessed alignment features formed in the optical array unit, where engaging the one or more protruding alignment features with the one or more recessed alignment features provides an optical alignment of the plurality of optical paths with the plurality of waveguides.

One example embodiment is an optical array unit including: a plurality of optical paths optically connected to a connection edge of the optical array unit; and one or more passive recessed alignment features formed in the optical array unit, where the one or more recessed alignment features are configured to engage with one or more protruding alignment features of a photonic die to provide an optical connection from the connection edge to the photonic die.

One example embodiment includes a method that includes: inserting a plurality of optical fibers into a plurality of grooves in a base unit of an optical array unit, affixing a lid unit to the base of the optical array unit to secure the optical fibers and to form the optical array unit, defining one or more recessed alignment features in the optical array unit, and processing the optical array unit to form the one or more recessed alignment features. Other embodiments of this aspect include corresponding computer systems, apparatus, and computer programs recorded on one or more computer storage devices, each configured to perform the actions of the methods.

### Example Embodiments

Optoelectronic devices and optical fibers have greatly increased the speed and reliability of electronic communication while also reducing the costs of communicating. However, one of the most costly and time-consuming steps in manufacturing optical transceivers and other photonic devices is aligning optical fibers to photonics dies of an optoelectronic device.

Optical array units, such as FAUs are joined and/or connected to photonics dies using an active alignment or passive alignment process. In an active alignment process, an FAU is aligned to a photonic die while monitoring how much light is transferred into the die. While active alignment can provide accurate results in creating an optical connection between the FAU and the photonic die, active alignment tends to be slow and costly due to various complexities in alignment processes and alignment equipment needed to solve the complexities.

In passive alignment, an FAU is joined to a photonic die without monitoring the optical power and coupling efficiency, resulting in a generally faster alignment process. However, in order to achieve low loss coupling, very precise fiducials, grooves, and other alignment reference features are needed in the FAU, which can significantly increase cost of the FAU and the photonic die.

The systems and methods described herein provide for an optical array unit with alignment features which simplifies an optical alignment process and reduces the time and equipment costs needed to join optical fibers to an optoelectronic device by forming alignment features into the optical array unit during the fabrication of the optical array unit using lower cost laser drilling and/or molding during the fabrication of the optical array unit.

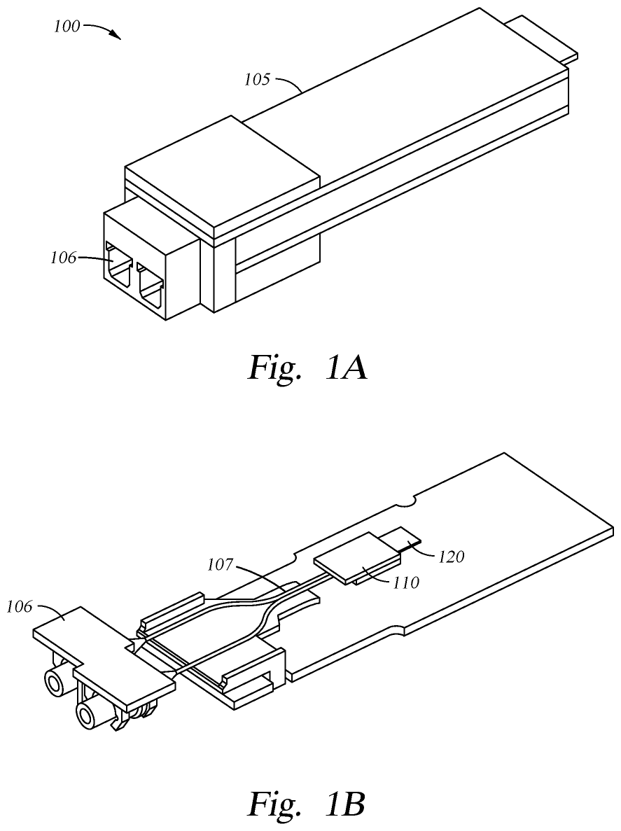

FIG. 1A illustrates an example optical transceiver 100, while FIG. 1B illustrates an example inside view of the optical transceiver 100, according to embodiments described herein. The optical transceiver 100 includes any type of optoelectronic device that sends and receives optical signals via connected fibers. The optical transceiver 100 includes a transceiver portion 105 and an optical fiber connection 106 as shown in FIG. 1A. The optical fiber connection 106 couples to one or more external optical fibers (not shown) plugged into the optical transceiver 100.

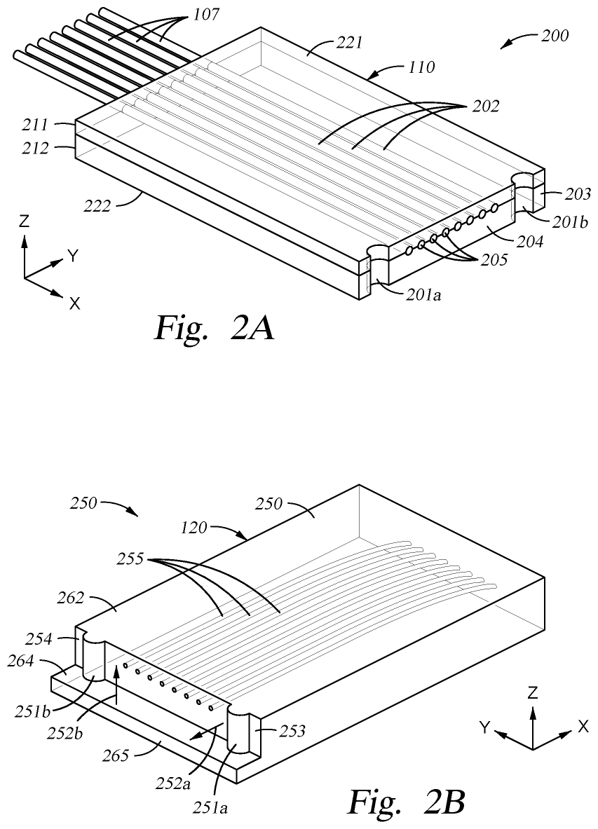

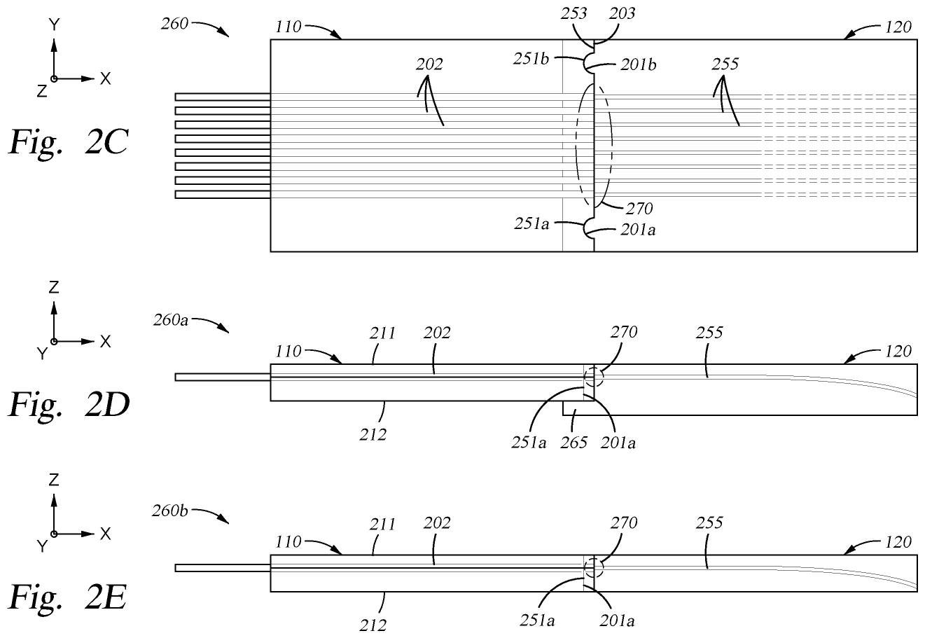

As shown in FIG. 1B, the optical fiber connection 106 is also coupled to the optical fibers 107 which optically connect the signals received from the external optical fibers via the optical fiber connection 106 to an optoelectronic/photonic element in the transceiver, such as a photonic die 120. An optical array unit 110 optically connects the optical fiber connection 106 to the photonic die 120. Various example optical array units similar to optical array unit 110 and methods for producing the optical array unit 110 are described herein in relation to the FIGS. 2A-8C.

FIG. 2A illustrates an example optical array unit 110, according to embodiments described herein. The features of the arrangement 200 shown in FIGS. 2A, C, D, and E are an example variation of the optical array unit 110 shown in FIG. 1B. The optical array unit 110 may be produced/manufactured/fabricated in part by using known optical array unit and/or FAU production methods. For example, a base unit 212 of an optical array unit 110 may be produced with a plurality of v-grooves 205 formed in the base unit 212. The optical fibers 107, as shown in FIGS. 1B and 1n FIG. 2A, inserted into the plurality of v-grooves 205 form a plurality of optical paths, such as optical paths 202. A lid 211 is affixed to the base unit 212 with an epoxy or other joining mechanism that secures the optical fibers 107 in place within the optical array unit 110. The optical array unit 110 in including the base unit 212 and the lid 211 may include one or more of a glass material, a silicon material, and a moldable material.

The optical paths 202 terminate at and provide an optical connection (e.g., via the optical fibers 107) to a connection edge 203 of the optical array unit 110. The connection edge 203 includes a connection surface 204 with recessed alignment features 201a and 201b formed into the connection surface 204 of the connection edge 203. In some examples, the optical paths 202 are disposed between the recessed alignment features 201a and 201b. The one or more recessed (female) alignment features 201a-b may be defined and formed into the optical array unit 110 using one or more of a sawing operation, a molding operation, a polishing operation, an etching operation, and/or a laser patterning operation as described herein. In some examples described herein, the recessed alignment features 201a and 201b include notches formed by laser drilling and molding processes, which provides a cheap and simple less complex method to produce alignment features in the optical array unit 110.

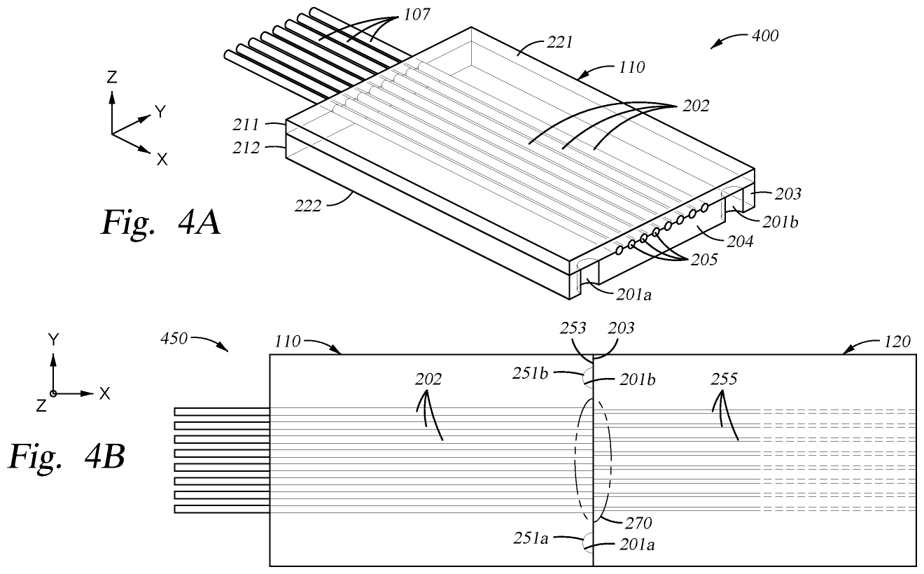

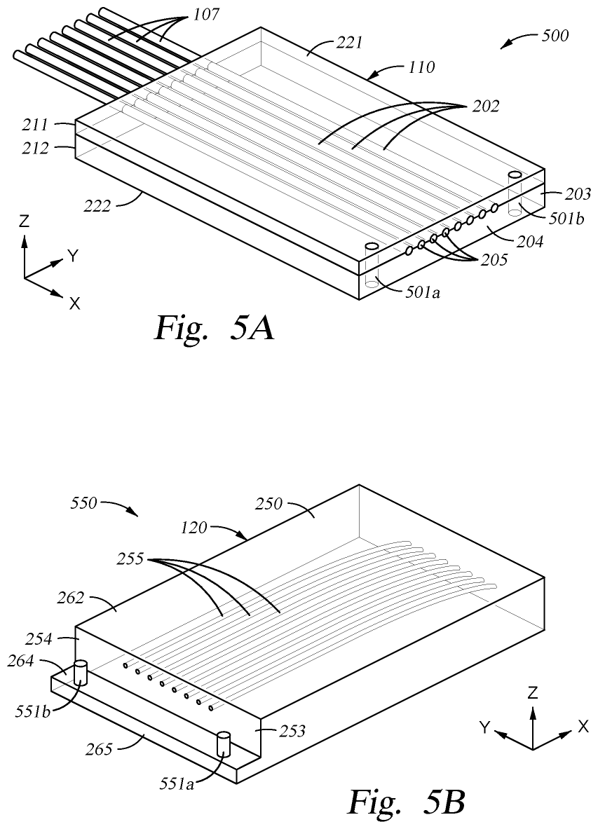

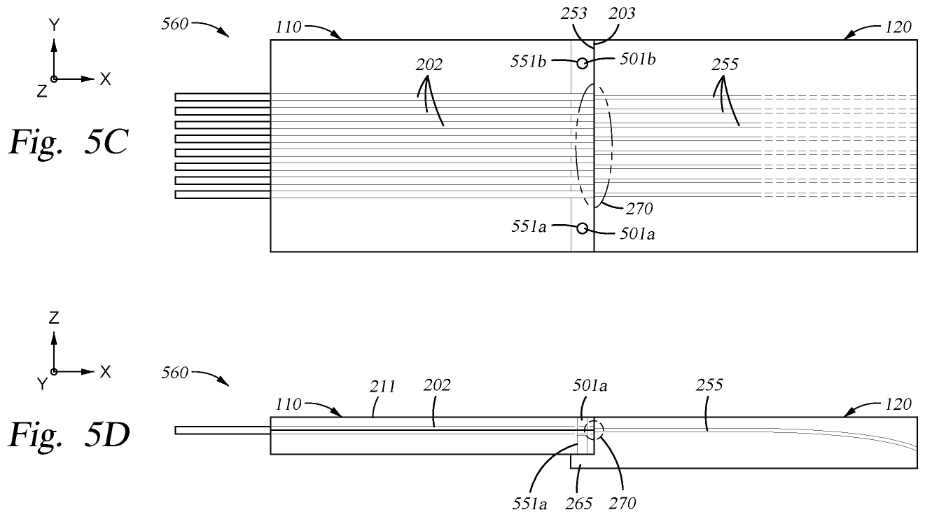

The recessed alignment features 201a and 201b may include any geometric shape which provides engagement and/or interlocking functions when matched to a respective protruding (male) alignment feature. For example, the recessed alignment features 201a and 201b may include a notch or a pair of notches, where each respective notch engages with a respective protruding alignment feature on a photonic die. While shown the recessed alignment features 201a and 201b are shown as formed in the connection surface 204 in FIG. 2A, the recessed alignment features may include features formed in other parts and/or surfaces of the optical array unit 110 as described herein in relation to FIGS. 4A-5D.

In the arrangement 200, the recessed alignment features 201a and 201b are formed through a bottom surface 222 of the optical array unit and pass through the base unit 212 and the lid 211 to a top surface 221 of the optical array unit 110. In some examples, the recessed alignment features 201a and 201b in the arrangement 200 are formed in the optical array unit 110 after the lid 211 is affixed to the base unit 212. The recessed alignment features 201a and 201b are dimensioned to interlock and/or engage with protruding alignment features formed in a photonic die.

FIG. 2B illustrates an example photonic die, according to embodiments described herein. The photonic die 120 includes a substrate 250 with a plurality of waveguides formed in the substrate 250, such as waveguides 255. In one embodiment, the plurality of waveguides, waveguides 255, are optically connected to an integrated electrical component (not shown) of the photonic die 120 and to a connection edge 253 of the photonic die 120. The connection edge 253 joins and/or couples to the connection edge 203 when the photonic die 120 engages with the optical array unit 110, as described herein in relation to FIGS. 2C-E. The substrate 250 also includes protruding alignment and/or guide features, such as alignment features 251a and 251b extending in a first direction 252a from an alignment surface 254 associated with the connection edge 253 of the photonic die 120. The substrate 250 also includes a top surface 262 and a reference surface 264 where the reference surface 264 is recessed from the top surface 262 of the photonic die forming an alignment shelf 265 in the photonic die 120. The protruding alignment features 251a and 251b may also extend from a second direction 252b from the reference surface 264 in addition to the alignment surface 254. The alignment features 251a and 251b are shaped and/or dimensioned to interlock and/or engage with recessed alignment features 201a and 201b in the optical array unit 110 as shown in FIG. 2C.

The alignment shelf 265 serves as a vertical alignment feature when the optical array unit 110 is joined/engaged to the photonic die 120 as shown in FIGS. 2D and 2E. The protruding alignment features 251a and 251b, recessed alignment features 201a and 201b, and the alignment shelf 265 serve as horizontal alignment features as described in relation to FIG. 2C. The combined alignment features of the photonic die 120 and the optical array unit 110 reduce a number of alignment axes that have to be accounted for during an alignment process between the two components from 4-6 axes without the alignment features to 1-2 axes with the alignment features.

FIG. 2C illustrates an example top view of an optical array unit engaged with a photonic die, according to embodiments described herein. An engagement 260 includes the optical array unit 110 joined, coupled, engaged, or otherwise interlocked with the photonic die 120. In some examples, the engagement 260 is secured with an epoxy, such as an index matching epoxy which secures the optical array unit 110 and the photonic die 120 in place. As shown in FIG. 2A, the optical array unit 110 includes features of the arrangement 200 as described in relation to FIG. 2A. The recessed alignment features 201a engages with the protruding alignment feature 251a. Similarly, the recessed alignment features 201b is engaged with the protruding alignment feature 251b. The connection edge 253 of the photonic die 120 couples (e.g., via a butt-coupled) to the connection edge 203 of the optical array unit 110. An alignment provided by the engaged alignment features and the coupling between the connection edges in the engagement 260 creates an optical alignment, such as optical connection 270, between the optical paths 202 and the waveguides 255. In some examples, the engaged alignment features provide for a passive alignment for the optical array unit 110 to the photonic die 120 along the y-axis shown in FIG. 2C.

In some examples, an index matching epoxy and/or other adhesives applied between the optical array unit 110 and the photonic die 120 holds the photonic die 120 and optical array unit 110 in place and together which improves coupling between the components. In some examples, the waveguides 255 include a mode size that provide a direct coupling from the optical paths 202 (e.g., the optical fibers 107) and the photonic die 120. In some examples, a lens and/or other optic device may be placed between the optical paths 202 and the waveguides 255 to provide an efficient optical coupling.

FIGS. 2D-E illustrates example side views of an optical array unit engaged with a photonic die, according to embodiments described herein. In some examples, the optical array unit 110 in the arrangement 200 engages with the photonic die 120 such that the optical array unit 110 is disposed on the shelf 265 as shown in engagement 260a in FIG. 2D. In this example, the alignment shelf 265 provides an alignment in a vertical z-axis enabling the optical connection 270. The optical paths 202 are aligned and optically connected to the waveguides 255 via the optical connection 270. The recessed alignment feature 201a engages with the protruding alignment feature 251a.

FIG. 2E illustrates an example optical array unit, optical array unit 110, coupled to a photonic die 120 without an alignment shelf in the engagement 260b. The optical array unit 110 is coupled to the photonic die 120, and provides the optical connection 270. In this example, the alignment of optical array unit 110 may include active alignment processes and/or other passive alignment features (not shown) to ensure alignment along the z-axis.

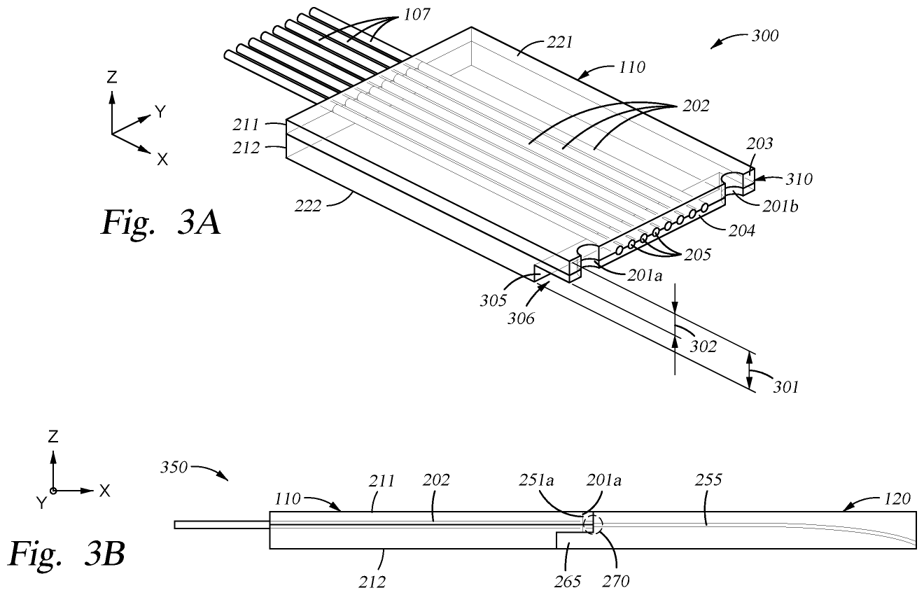

FIG. 3A illustrates an example shallow diced optical array unit, according to embodiments described herein. In some examples, the connection edge 203 of the optical array unit may be too thick or otherwise not properly dimensioned to properly couple with connection edge 253 of the photonic die 120. For example, a thickness 301 of the optical array unit 110 may not provide an appropriate alignment with the photonic die 120 and the alignment shelf 265. The optical array unit 110 in the arrangement 300 includes a shallow diced area including a recessed surface 305 in the connection surface 204, where the recessed surface 305 is recessed from the connection edge 203. A shallow diced area 306 created by the recessed surface 305 forms an alignment protrusion 310 in the optical array unit 110, where the alignment protrusion 310 includes a thickness 302 smaller than the thickness 301, and where the alignment protrusion 310 is disposed over the alignment shelf 265 of the photonic die 120 when the optical array unit 110 is engaged with the photonic die 120 as shown in FIG. 3B. The formation of the shallow diced area can be accomplished by a dicing operation, but may also be formed with molding operations, laser patterning operations, etc.

FIG. 3B illustrates an example side view of a shallowed diced optical array unit engaged with a photonic die, according to embodiments described herein. The optical array unit 110 in the arrangement 300 horizontally couples to the photonic die 120 in an engagement 350 in a manner similar to that shown in FIG. 2C (i.e., along the y-axis shown in FIG. 2C). Similarly, the alignment protrusion 310 provides alignment in the vertical z-axis as shown in FIG. 3B, (in a manner similar to that described in FIG. 2D) where the optical array unit 110 couples to the photonic die 120 to provide the optical connection 270 between the optical paths 202 and the waveguides 255.

FIG. 4A illustrates an example optical array unit with preformed recessed alignment features, according to embodiments described herein. In some examples, the base unit 212 of the optical array unit 110 includes preformed alignment features. The optical array unit 110 in arrangement 400 includes the recessed alignment features 201a and 201b, where the features are preformed in the base unit 212 prior to attaching the optical fibers 107 and affixing the lid 211. The lid 211 in the arrangement 400 is shown disposed over the recessed alignment features 201a and 201b, but the lid 211 may also be positioned and/or disposed further back on the optical array unit 110 to avoid introducing epoxy or other joined material into the recessed alignment features 201a and 201b. In the arrangement 400, the connection edge 203 is primarily located on the base unit 212 and is coupled/joined to the connection edge 253 as shown in FIG. 4B.

FIG. 4B illustrates an example top view of an optical array unit with preformed recessed alignment features engaged with a photonic die, according to embodiments described herein. In the engagement 450 shown, the photonic die 120 couples to the optical array unit 110 and the connection edge 203 of the optical array unit 110 is connected to the connection edge 253 of the photonic die. As shown, the optical array unit 110 includes the features shown in the arrangement 400 such that the lid is disposed over the recessed alignment features 201a and 201b, which engage with the protruding alignment features 251a and 251b of the photonic die 120. The optical array unit 110 may vertically couple with the photonic die 120 in any of the options described in relation to FIGS. 2D and 2E. The arrangement 400 may also include an alignment protrusion 310 as described in relation to FIGS. 3A and 3B.

FIG. 5A illustrates an example optical array unit with hole features, according to embodiments described herein. The optical array unit 110 in the arrangement 500 includes the holes 501a and 501b which are alignment features (holes) formed in at least the bottom surface 222 of the base unit 212 of the optical array unit 110. As shown in FIG. 5A, the holes 501a and 501b are formed through the bottom surface 222 and pass through to the top surface 221 of the lid 211. The holes 501a and 501b may also extend through a portion of the optical array unit 110 (e.g., through the base unit 212 and/or through a portion of the base unit 212 and/or lid 211. Each respective hole, such as the holes 501a and 501b, are dimensioned to engage with a respective pin feature formed on the photonic die 120 described in FIG. 5B.

FIG. 5B illustrates an example photonic die with pin features, according to embodiments described herein. The photonic die 120 in the arrangement 550 includes the waveguides 255, alignment shelf 265, connection edge 253, alignment surface 254, and the reference surface 264 as described in relation to FIG. 2B. The arrangement 550 also includes the pin features 551a and 551b protruding/extending from the reference surface 264, the pin features 551a and 551b are dimensioned to engage and/or otherwise fit into the holes 501a and 501b of the optical array unit 110 in the arrangement 500 shown in FIG. 5A.

FIG. 5C illustrates an example top view and FIG. 5D illustrates an example side view of an optical array unit with hole features engaged with a photonic die with pin features, according to embodiments described herein. The engagement 560 in FIG. 5C is similar to the engagement 260 shown in FIG. 2C. The connection edge 253 of the photonic die 120 couples (e.g., butt-coupled) to the connection edge 203 of the optical array unit 110. An alignment provided by the engaged alignment features and the coupling between the connection edges in the engagement 260 provides the optical connection 270 between the optical paths 202 and the waveguides 255. The engaged alignment features provide a passive alignment for the optical array unit 110 to the photonic die 120 along the y-axis shown in FIG. 2C. The engagement 560 includes the pin features 551a and 551b engaged with the holes 501a and 501b. The engagement 560 shown in FIG. 5D includes a shallowed diced optical array unit 110 as described in relation to FIGS. 3A-B. The engagement 560 may also be formed according to the engagements 260a and 260b (i.e., without an alignment protrusion).

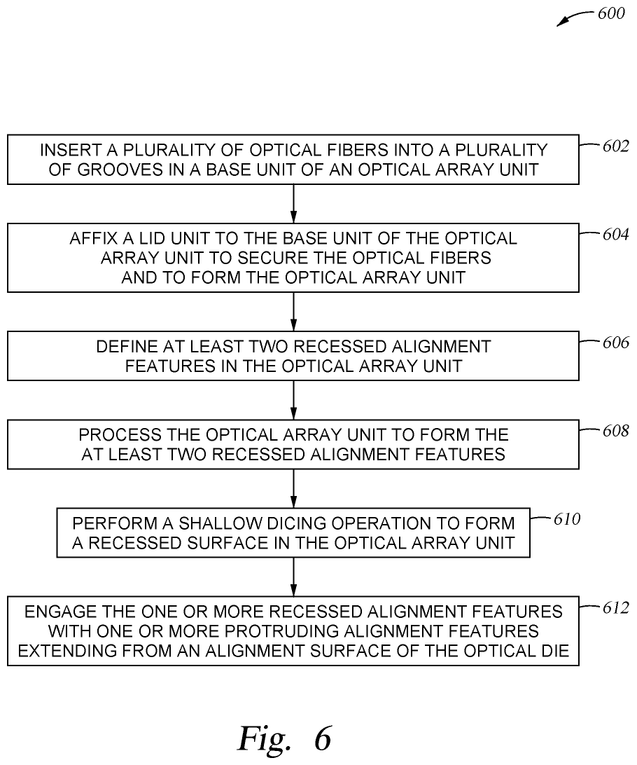

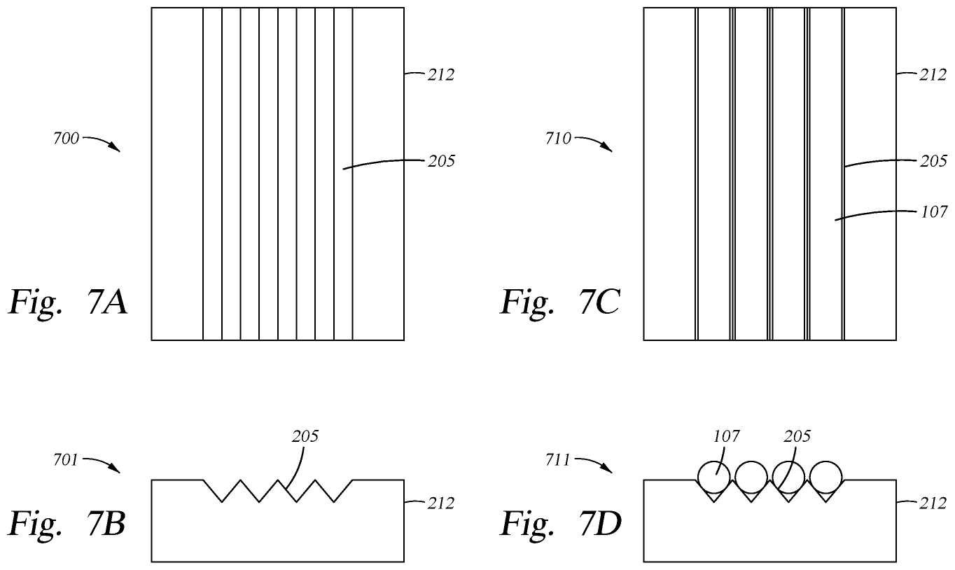

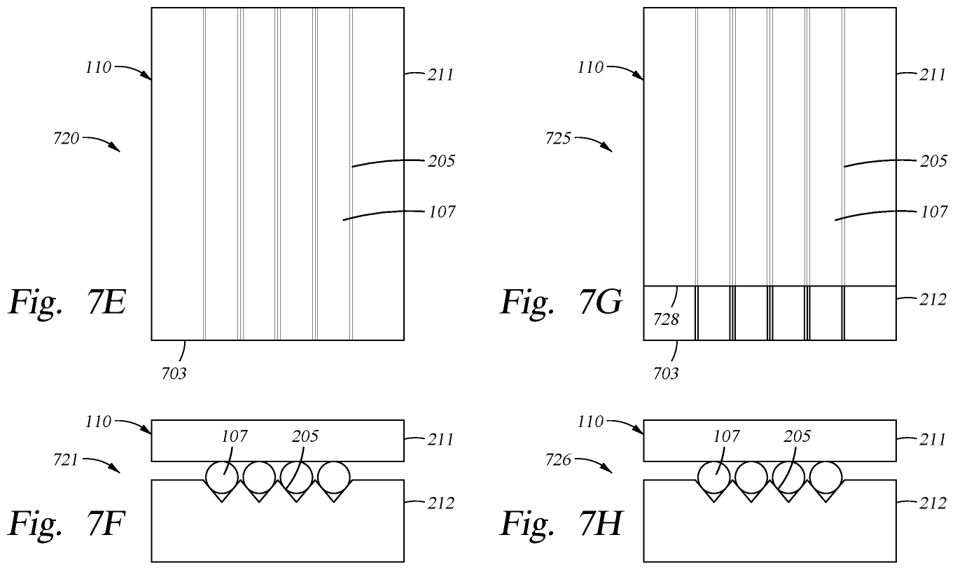

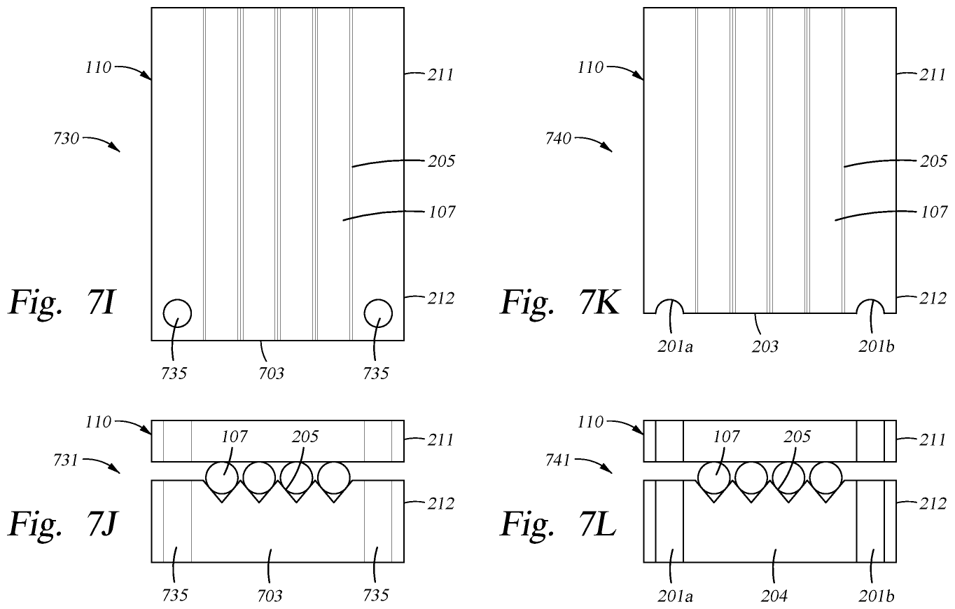

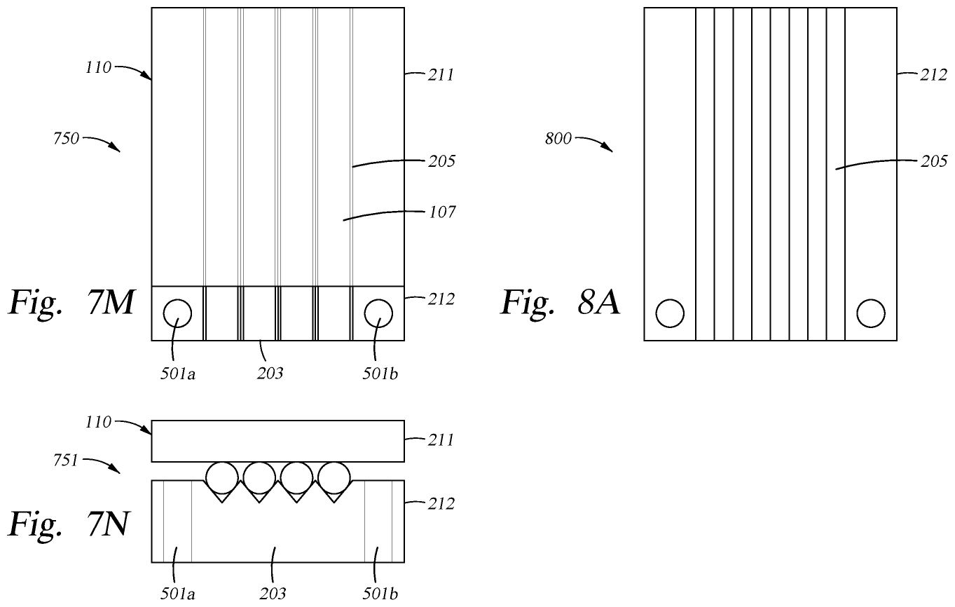

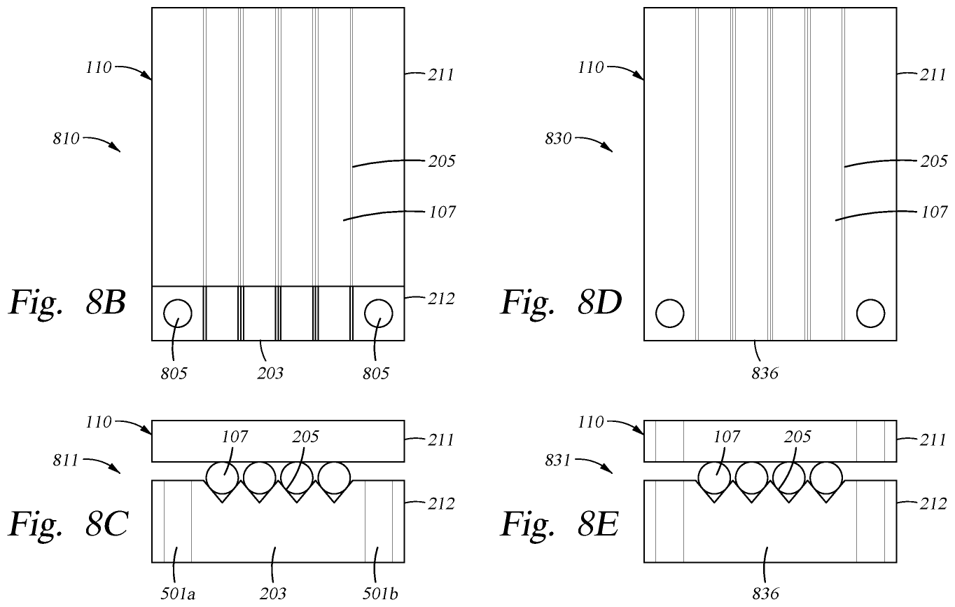

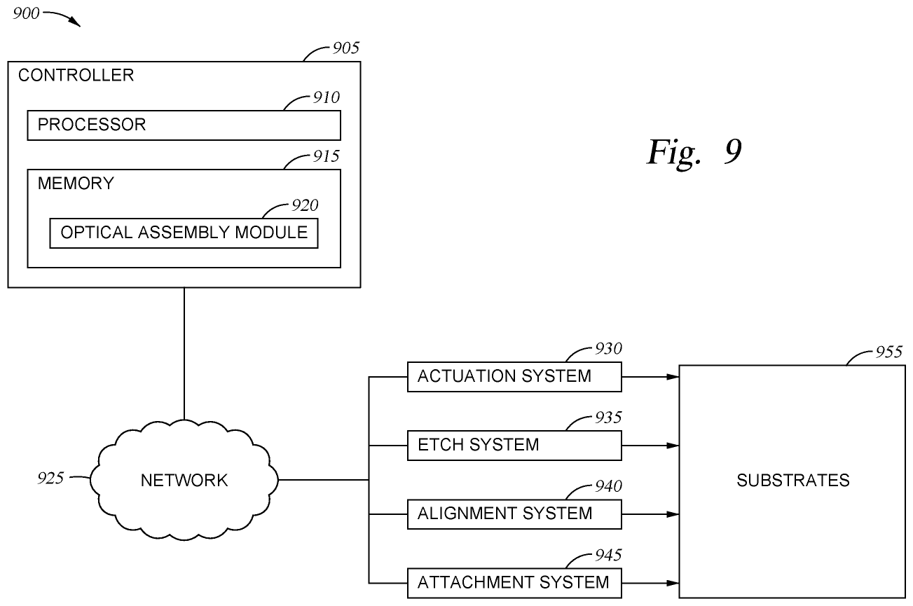

FIG. 6 is a flowchart illustrating operations of an example method, method 600, for the production of an optical array unit, according to embodiments described herein. For clarity, reference will be made to FIGS. 7A-8E through the description of method 600. In some examples, a base unit of an optical array unit is provided prior to beginning the method 600. For example, as shown in top view 700 in FIG. 7A and side view 701 in FIG. 7B, the base unit 212 including the v-grooves 205 is provided. The base unit 212 may be formed through typical manufacturing procedures for producing a base unit for optical array unit and/or FAU including the formation of the v-grooves 205.

Method 600 begins at block 602, where a plurality of optical fibers are inserted into a plurality of grooves in a base unit of an optical array unit. For example, as shown top view 710 in FIG. 7C and side view 711 in FIG. 7D, the optical fibers 107 are inserted into the v-grooves 205 of the base unit 212. In some examples, the optical fibers 107 form the optical paths 202 as described herein. In some examples, the optical fibers 107 include standard optical fibers, polarization maintaining fibers, multicore fibers, etc.

At block 604, a lid unit is affixed to the base of the optical array unit to secure the optical fibers and to form the optical array unit. For example, as shown in top view 720 in FIG. 7E and side view 721 in FIG. 7CF the lid 211 is affixed to the base unit 212 to secure the optical fibers. The lid may be affixed, joined, and/or otherwise attached to the base unit using standard optical array and FAU fabrication techniques, including using an epoxy, such as an index matching epoxy, to secure the lid 211 to the base unit 212. The lid 211 may positioned flush with a surface 703 as shown in top view 720. In another example, the lid may be positioned at a set-back position 728 as shown in top view 725 in FIG. 7G and side view 726 in FIG. 7H. The set-back position provides for various alignment features to be formed in the base unit 212 without interacting with the lid 211.

At block 606, one or more recessed alignment features are defined in the optical array unit. For example, as shown in top view 730 in FIG. 7I and side view 731 in FIG. 7J, the recessed alignment features 735 are defined in the optical array unit. In some examples, at least two recessed alignment features similar to the recessed alignment feature 735 are defined in the optical array unit. The recessed alignment features 735 may include holes defined in the base unit 212 and holes defined in the base unit 212 and the lid 211. The features are defined back from an edge or surface of the optical array unit 110 at this step. In some examples, the recessed alignment features 735 may be formed into the recessed alignment features 201a and 201b and or the holes 501a and 501b as described herein.

In some examples, the one or more recessed alignment features are defined in a base unit of the optical array unit prior to a lid being affixed to the base unit. For example, as shown the top view 800 in FIG. 8A, the alignment features 805 are defined in the base unit prior to the formation of the optical array unit 110 as described in relation to FIGS. 7B-D. The base unit 212 includes the v-grooves 205. Once the alignment features 805 are defined in the base unit 212, the optical fibers 107 are inserted into the v-grooves 205 and the lid 211 is affixed to the base unit 212 as shown top view 810 in FIG. 8B and side view 811 in FIG. 8C and in a similar manner as discussed in relation to blocks 602 and 604. In this example, the lid may be set back at set back 812 as shown in FIG. 8B or may be affixed flush with a surface 836 as shown in top view 830 in FIG. 8D and side view 831 in FIG. 8E. The optical array units shown in FIGS. 8B and 8E are further processed according to the processes described in relation to FIGS. 7F-N.

At block 608, the optical array unit is processed to form the one or more recessed alignment features. For example, as shown top view 740 in FIG. 7K, the optical array unit 110 is sawed, cleaved, polished, etc. to reveal the recessed alignment features 201a and 201b at the connection edge 203 (as shown in top view 740 in FIG. 7K) and on the connection surface 204 (as shown in side view 741 in FIG. 7L). In another example shown in a top view 750 in FIG. 7M and side view 751 in FIG. 7N, the optical array unit 110 is polished to form the connection edge 203 and the connection surface 204. In this example, the recessed alignment features 735 are formed in to the holes 501a and 501b.

At block 610, a shallow dicing operation is optionally performed to form a recessed surface in the optical array unit, wherein the recessed surface is recessed from a connection edge of the of the optical array unit forming an alignment protrusion for the optical array unit as described in relation to FIG. 3A-B. The shallow diced area 306 be cleaved, sawed, polished, and/or removed in one or more other processes to form the alignment protrusion 310.

At block 612 the one or more recessed alignment features are engaged with one or more protruding alignment features extending from an alignment surface of the photonic die. In some examples, the optical array unit 110 and the photonic die 120 are joined and/or otherwise engaged by an alignment or optical fabrication system, such as discussed in relation to FIG. 9. In some examples, engaging a recessed alignment features with a protruding alignment feature include matching the alignment features into the various engagements discussed herein. In some examples, the engagement between the optical array unit 110 and the photonic die 120 is secured with an epoxy, such as an index matching epoxy which secures the aligned optical array unit 110 and the photonic die 120 in place.

FIG. 9 is a block diagram of a system 900 for constructing an optical apparatus including an optical array unit and/or photonic die, according to one or more embodiments. Features of the system 900 may be used in conjunction with other embodiments, such as the various transceivers, optical array units, and photonic dies, which are discussed above in relation to FIGS. 1A-5D.

The system 900 comprises a controller 905 comprising one or more computer processors 910 and a memory 915. The one or more computer processors 910 represent any number of processing elements that each can include any number of processing cores. Some non-limiting examples of the one or more computer processors 910 include a microprocessor, a digital signal processor (DSP), an application-specific integrated chip (ASIC), and a field programmable gate array (FPGA), or combinations thereof. The memory 915 may comprise volatile memory elements (such as random access memory), non-volatile memory elements (such as solid-state, magnetic, optical, or Flash-based storage), and combinations thereof. Moreover, the memory 915 may be distributed across different mediums (e.g., network storage or external hard drives).

The memory 915 may comprise a plurality of “modules” for performing various functions described herein. In one embodiment, each module includes program code that is executable by one or more of the computer processors 910. However, other embodiments may include modules that are partially or fully implemented in hardware (i.e., circuitry) or firmware of the controller 905. As shown, the memory 915 comprises an optical assembly module 920 configured to control various stages of manufacturing (or assembling) an optical apparatus. The optical assembly module 920 is configured to communicate control signals to one or more systems via a network 925. The network 925 may include one or more networks of various types, including a personal area network (PAN), a local area or local access network (LAN), a general wide area network (WAN), and/or a public network (e.g., the Internet).

As shown, the system 900 comprises an actuation system 930, an etch system 935, an alignment system 940, and an attachment system 945, each of which is communicatively coupled with the controller 905 via the network 925. Based on control signals received from the controller 905, one or more of these systems may be configured to manipulate one or more substrates 955, such as semiconductor substrates (e.g., photonic die 120) and/or glass substrates (the optical array unit 110 and related components) when constructing the optical apparatus.

In some embodiments, the actuation system 930 is configured to alter an orientation of the substrates 955 (e.g., translation and/or rotation) between different stages of processing, maintain an orientation of the substrates 955 during the processing, and so forth. For example, the actuation system 930 may comprise one or more robotic arms and/or gripping systems.

In some embodiments, the etch system 935 is configured to etch the substrates 955 to form features therein, according to any suitable etching technique(s). For example, the etch system 935 may be configured to form openings through the substrates 955 for forming vias, form grooves from a surface of the substrates 955, form a recess from the surface, form alignment features, and so forth. In one embodiment, the etch system 935 uses an anisotropic etch process such as deep reactive-ion etching (DRIE). In an alternate embodiment, one or more functions of the etch system 935 may be performed using other techniques, such as laser drilling, sawing, polishing, or machining.

As part of constructing the optical apparatus, a semiconductor laser, a plurality of optical fibers, and/or other optical and/or electronic components may be placed on the substrates 955. In some embodiments, the alignment system 940 is configured to perform an optical alignment of the semiconductor laser and/or the plurality of optical fibers. For example, the alignment system 940 may comprise an active alignment system configured to provide optical signals to the optical fibers and/or apply an electrical signal to the semiconductor laser to generate an optical signal.

In some embodiments, the alignment system 940 is used to optically align the semiconductor laser and the plurality of optical fibers after attachment to the substrates 955. For example, the alignment system 940 may manipulate the substrates 955 to align the semiconductor laser and the plurality of optical fibers with respective waveguides formed in a semiconductor substrate. In other embodiments, the alignment system 940 may operate in conjunction with the actuation system 930 to manipulate the substrates 955 and/or the semiconductor substrate.

In some embodiments, the attachment system 945 is configured to attach the substrates 955 with one or more of: other substrates, substrates 955, the semiconductor substrate, the plurality of optical fibers, the semiconductor laser, and other optical and/or electronic components according to any suitable techniques. In some embodiments, the attachment system 945 may be used in multiple attachment stages. For example, the attachment system 945 may be configured to apply an epoxy between the optical fibers and a first one of the substrates 955, to apply an epoxy between the first one and a second one of the substrates 955, to apply an epoxy between the first one of the substrates 955 and a semiconductor substrate, and so forth. The attachment system 945 may further be configured to cure the epoxy, e.g., by applying an ultraviolet (UV) light.

In some embodiments, the attachment system 945 may further be configured to apply conductive material to couple the semiconductor laser and/or other electronic components with conductive traces on the substrates 955. For example, the attachment system 945 may apply a conductive layer to bond conductive contacts of the semiconductor laser with conductive traces on the substrates 955. The attachment system 945 may further be configured to couple conductive traces on the substrates 955 with conductive portions of the semiconductor substrate. For example, the attachment system 945 may wire bond or apply solder/conductive epoxy to connect the conductive traces on the substrates 955 with corresponding conductive traces on the semiconductor substrate.

The controller 905 may be implemented in any suitable form. In some embodiments, the controller 905 comprises a singular computing device providing centralized control of the construction process. In other embodiments, the controller 905 represents multiple, communicatively coupled computing devices, which may or may not have centralized control. For example, some or all of the actuation system 930, the etch system 935, the alignment system 940, and the attachment system 945 may comprise local controllers that are in communication with the controller 905 via the network 925. In an alternate embodiment, the operation of the actuation system 930, the etch system 935; the alignment system 940, and the attachment system 945 may be achieved independently of centralized control.

Further, while the system 900 is described primarily in terms of manipulating the substrates 955, the various systems described herein may interact with other components as part of constructing the optical apparatus. For example, the actuation system 930 may be configured to manipulate the plurality of optical fibers, the semiconductor laser, and other electrical and/or optical components.

To further improve optical coupling, vision-assisted alignment or active alignment may be performed in a limited number of axes. Since interlocking the alignment features or other features of the substrate is effective to provide at least a coarse alignment of the optical fibers with the waveguides of the substrate, the vision-assisted alignment or the active alignment may be used to provide a finer alignment while adding minimal process time. Use of these simple and inexpensive mechanical features to “pre-align” the optical fibers to the photonic chip can reduce or eliminate the cost of automation (e.g., precision placement and peak searching algorithms), ultimately reducing the overall cost of alignment.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality and operation of possible implementations of systems, methods and computer program products according to various embodiments. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In view of the foregoing, the scope of the present disclosure is determined by the claims that follow.

1. An apparatus, comprising:
an optical array unit comprising:
a top surface and a bottom surface opposite the top surface;
a plurality of optical paths optically connected to a connection edge of the optical array unit, the plurality of optical paths positioned between the top and bottom surfaces such that the plurality of optical paths extend along a plane of the top and bottom surfaces; and
an alignment feature that extends to the top and bottom surfaces and that defines a hole that has a cross-sectional area in the plane of the top and bottom surfaces that forms a closed shape; and
a photonic die comprising:
a plurality of waveguides formed in the photonic die and optically connected to the plurality of optical paths at a connection edge of the photonic die; and
a protruding alignment feature extending from an alignment surface of the photonic die, wherein the protruding alignment feature is dimensioned to engage with the hole, wherein an engagement of the protruding alignment feature with the hole optically aligns the plurality of optical paths with the plurality of waveguides.

2. (canceled)

3. The apparatus of claim 1,
wherein the photonic die further comprises a top surface and a reference surface, wherein the reference surface is recessed from the top surface of the photonic die, wherein the protruding alignment feature comprises a pin feature extending from the reference surface of the photonic die and dimensioned to engage the hole.

4. (canceled)

5. The apparatus of claim 1, wherein the optical array unit comprises one or more of a glass material, a silicon material, and a moldable material.

6. The apparatus of claim 5, wherein the alignment feature is formed into the optical array unit via one or more of a sawing operation, a molding operation, an etching operation, and a laser patterning operation.

7. The apparatus of claim 1, wherein the optical array unit further comprises:
a base unit with grooves formed into the base unit, wherein the base unit defines a plurality of grooves that are each dimensioned to receive an optical fiber of a plurality of optical fibers, wherein the plurality of optical fibers provide the plurality of optical paths in the optical array unit; and
a lid unit affixed to the base unit to secure the plurality of optical fibers in the plurality of grooves.

8. An optical array unit comprising:
a top surface and a bottom surface opposite the top surface;
a plurality of optical paths terminating at a connection edge of the optical array unit, the plurality of optical paths positioned between the top and bottom surfaces such that the plurality of optical paths extend along a plane of the top and bottom surfaces; and
at least two alignment features that extend to the top and bottom surfaces, wherein each alignment feature defines a hole that has a cross-sectional area in the plane of the top and bottom surfaces that forms a closed shape, and wherein each hole is configured to engage with respective protruding alignment features of a photonic die to provide an optical connection from the connection edge to the photonic die.

9. (canceled)

10. (canceled)

11. (canceled)

12. The optical array unit of claim 8, wherein the optical array unit comprises one or more of a glass material, a silicon material, and a moldable material.

13. The optical array unit of claim 12, wherein the at least two alignment features are formed into the optical array unit via one or more of a sawing operation, a molding operation, an etching operation, and a laser patterning operation.

14. The optical array unit of claim 8, wherein the optical array unit further comprises:
a base unit with grooves formed into the base unit, wherein the base unit defines a plurality of grooves that are each dimensioned to receive an optical fiber of a plurality of optical fibers, wherein the plurality of optical fibers provide the plurality of optical paths in the optical array unit; and
a lid unit affixed to the base unit to secure the plurality of optical fibers in the plurality of grooves.

15. A method comprising:
inserting a plurality of optical fibers into a plurality of grooves in a base unit of an optical array unit;
affixing a lid unit to the base unit of the optical array unit to secure the plurality of optical fibers and to form the optical array unit; and
forming a recessed alignment feature in the optical array unit.

16. The method of claim 15, further comprising:
engaging the recessed alignment feature with a protruding alignment feature extending from an alignment surface of a photonic die,
wherein a plurality of waveguides are formed in the photonic die and optically connected to a connection edge of the photonic die;
wherein the protruding alignment feature is dimensioned to engage with a respective recessed alignment feature formed in the optical array unit; and
wherein engaging the recessed alignment feature with the protruding alignment feature provides an optical alignment of the plurality of optical fibers with the plurality of waveguides.

17. The method of claim 15, wherein defining one or more recessed alignment features formed in the optical array unit comprises defining at least one notch in a surface of a connection edge of the optical array unit, and
wherein processing the optical array unit to form the one or more recessed alignment features comprises forming the at least one notch via one or more of a sawing operation, a polishing operation, an etching operation, and a laser patterning operation.

18. The method of claim 15, wherein defining one or more recessed alignment features formed in the optical array unit comprises defining at least one hole in at least a first bottom surface of the optical array unit, and
wherein processing the optical array unit to form the one or more recessed alignment features comprises forming the at least one hole via one or more of a sawing operation, a polishing operation, an etching operation, and a laser patterning operation.

19. The method of claim 15, further comprising:
performing a shallow dicing operation to form a recessed surface in the optical array unit, wherein the recessed surface is recessed from a connection edge of the optical array unit forming an alignment protrusion for the optical array unit.

20. The method of claim 15, wherein the recessed alignment feature is formed in the base unit of the optical array unit prior to affixing the lid unit to the base unit.
